(19) United States
(12) Patent Application Publication
(10) Pub. No.: US 2009/0210790 A1
(43) Pub. Date: Aug. 20, 2009

(54) INTERACTIVE VIDEO

(75) Inventor: Mark Henry Thomas, Provo, UT (US)

Correspondence Address: Workman Nydegger;1000 Eagle Gate Tower, 60 East South Temple, Salt Lake City, UT, 84111, US

(73) Assignee: QGIA, LLC, Sandy, UT (US)

(21) Appl. No.: 12/032,535

(22) Filed: Feb. 15, 2008

(51) Int. Cl. G06F 3/01

(52) U.S. Cl. 715/719

(57) ABSTRACT

An interactive video player that is configured to play an interactive video that has interactive control(s). A user may remotely design the interactive video via a configuration interface through which a video may be selected, and one or more interactive controls may be specified. A configuration center may then automatically generate the interactive version of the video with the specified controls. The interactive video player may also have a data input mechanism through which a browsing user may conveniently enter data relating to the interactive video. One function of the interactive control(s) may be to present a browsable hyperlinked document upon selection of the control.

### BACKGROUND

The internet has transformed the way people live. Individuals now perform a large degree of shopping and other communication over the Internet. For instance, an on-line shopper might navigate to a web site hosted by a particular vendor, search for a product, add one or more products to an electronic shopping cart, and electronically check out. The product would then be made available to the on-line purchaser. Video technology has now become a common mechanism for delivering information about a product on-line. Certain vendors have now even added some level of interactivity to videos. For instance, one application allows a user to select on certain items displayed in the video. Upon selection of that item in the video, certain information would then be made visible regarding that item.

### BRIEF SUMMARY

At least some embodiments described herein relate to an interactive video player that is configured to play an interactive video. In accordance with one embodiment, a user may remotely design the interactive video via a configuration interface presented to the remote user. Through this configuration interface, the user may select a video and specify interactive aspects to be applied to the video. An interactive video generation center may then automatically generate an interactive version of the video that includes the specified interactive aspects. Thus, the user may design an interactive video with relative ease.

In one embodiment, the interactive video player may include a data input mechanism that allows a viewing user to enter data without first exiting the interactive video player. Optionally, the data input into the interactive video player may be synchronized with external data input destinations. This allows the data input to be designed to more closely align with the interactive video being displayed, thereby permitting an intuitive way to enter data.

In one embodiment, when a user navigates to a particular network site (e.g., a web page), it is detected that the network site references a particular interactive video. In response, the interactive video having interactive control(s) is presented to the user. If a user then selects one of the interactive controls of the interactive video, the interactive video player may then display a browsable as hyperlinked document without exiting the interactive video player itself This browsable hyperlinked document may appear within the context of the interactive player itself, without having to first exit the interactive video player. The user may then interact with the hyperlinked document to further navigate to other network sites.

This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 illustrates a network environment in which a designing user may design an interactive video using a configuration interface;

FIG. 2 schematically illustrates a configuration interface that may serve as the configuration interface of FIG. 1;

FIG. 3A illustrates a user interface of an example interactive video during an early stage of presentation;

FIG. 3B illustrates the example interactive video at the time an interactive control enters the display area;

FIG. 3C illustrates the example interactive video at the time that the animation associated with introduction of the interactive control has completed;

FIG. 3D illustrates the example interactive video after all of the interactive controls have entered the display area;

FIG. 4A illustrates an example user interface showing an internal shopping cart that is configured as part of the interactive video; and

FIG. 4B illustrates an example user interface showing a browsable hyperlinked document that may appear upon selection of another control within the interactive player of FIGS. 3A through 3D;

FIG. 5 illustrates an architecture of the interactive video player in the context of a browser;

FIG. 6 illustrates an environment in which a viewing user may view the interactive video; and

FIG. 7 illustrates an example computing system that may be used to employ embodiments described herein.

### DETAILED DESCRIPTION

In accordance with embodiments described herein, an interactive video player is configured to play an interactive video that has interactive control(s). A user may remotely design the interactive video via a configuration interface through which a video may be selected, and one or more interactive controls may be specified. A configuration center may then automatically generate the interactive version of the video with the specified controls. The interactive video player may also have a data input mechanism through which a browsing user may conveniently enter data relating to the interactive video. One function of the interactive control(s) may be to present a browsable hyperlinked document upon selection of the control. The browsable hyperlinked document may even appear within the framework of the video player without exiting the video player.

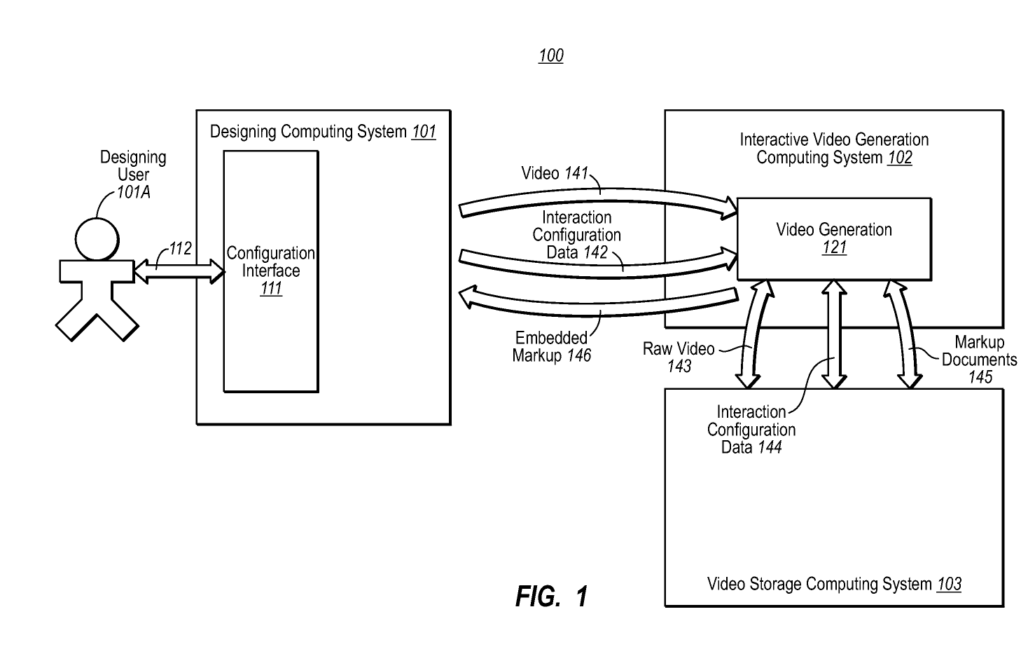

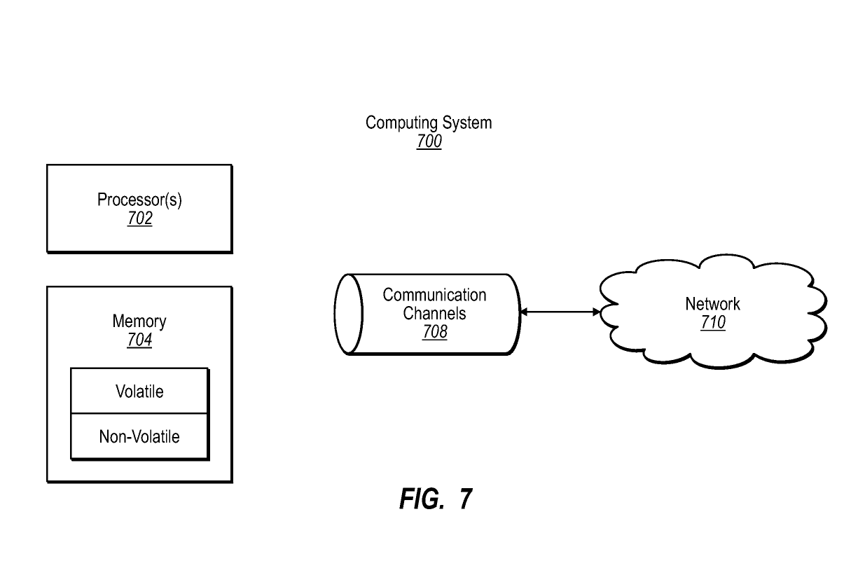

FIG. 1 illustrates a network environment 100 in which may occur the designing and generation of an interactive video in accordance with embodiments described herein. The network environment 100 includes a designing computing system 101, an interactive video generation computing system 102, and an interactive video storage computing system 103. Each of the computing systems 101, 102 and 103 may be structured as illustrated and described below with respect to the computing system 700 of FIG. 7.

The designing computing system 101 may be any computing system, but is as modified by the term “designing” merely to illustrate that in this example, the computing system 101 is used to allow a remote user 101A to design an interactive video. This designing operation may be performed using a configuration interface 111. FIG. 1 illustrates that the designing user 101A interfaces with the configuration interface 111 as represented by bi-directional arrow 112.

The configuration interface 111 may be, for example, a web page that is displayed through a browser of the designing computing system 101 when the browser navigates to a web page affiliated with the interactive video generation computing system 102. The interactive video generation computing system 102 may be any computing system, but is modified by the terms “interactive video generation” in that this is its function in the example environment 100 of FIG. 1. The same holds true for the other illustrated and described computing systems. They may be general purpose computing systems, but they are nevertheless modified with a particular function descriptor to emphasize their operation in the illustrated environment. The interactive video generation computing system 102 may also be referred to hereinafter as the “generation” computing system for short. In this description and in the claims, “video generation” or “generation” should be interpreted as taking a raw video, and adding interactive features to the raw video to thereby create an interactive video. In this description and in the claims, “raw video” is defined as video that does not include interactive controls.

The configuration interface 111 may alternatively be a File Transfer Protocol (FTP) client that performs file transfer between the designing computing system 101 and the interactive video generation computing system 102. The configuration interface 111 may be any other interface that allows the user to input data. The configuration interface 111 may be as straightforward as a single screen, or as may be dynamic, in which the user interfaces with a dynamic page, or interfaces with multiple pages in order to complete the configuration of the interactive video.

By interfacing with the configuration interface 111, the designing user 101A may specify a number of attributes of the interactive video. In this description and in the claims, an “interactive video” is to be interpreted broadly as including any video that includes one or more viewer-selectable controls or any data that, when interpreted by a video player, causes the video player to render video with one or more viewer-selectable controls, wherein the selection of the controls causes content to appear that is not in the raw video provided by the designing user.

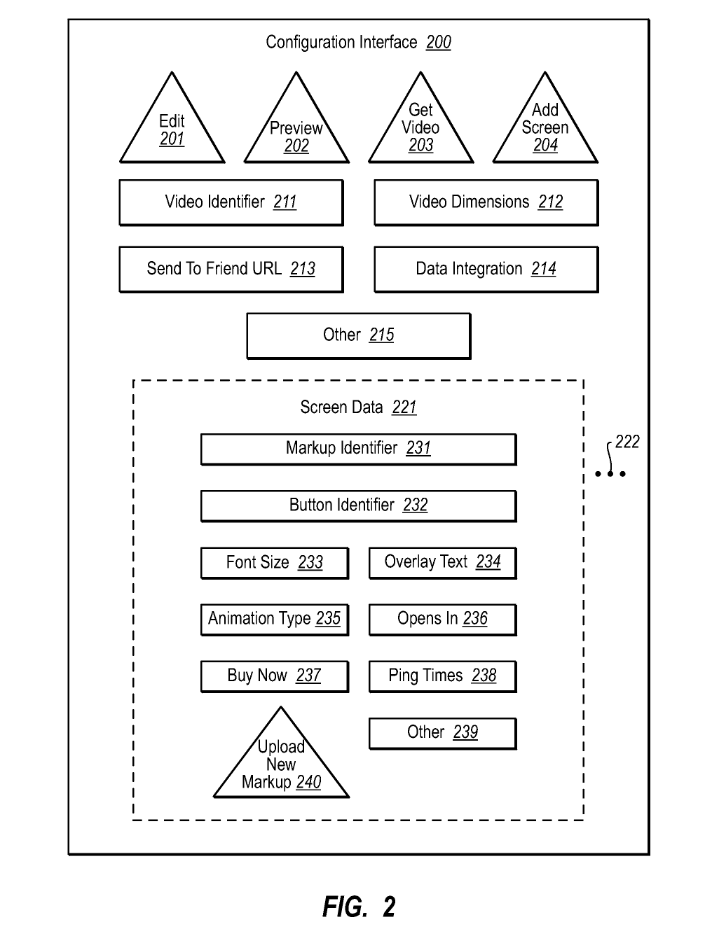

FIG. 2 symbolically illustrates an example configuration interface 200, which represents an example of the configuration interface 111 of FIG. 1. The particular layout and design of the configuration interface 111 is not critical for the broader aspects described herein. The configuration interface 200 is merely provided to show examples of the types of data that the designing user might specify when designing an interactive video.

The configuration interface 200 includes several controls 201 through 204 and several data fields 211 through 215. The data fields 211 through 215 (as well as the other data fields illustrated in FIG. 2) may ultimately be submitted to the generation computing system 202. In general, controls are symbolically represented in the configuration interface 200 using triangles, and the data fields are symbolically represented in the configuration interface 200 using rectangles. However, there is no limit to the way that controls or data fields are presented in the configuration interface 200 when presented to a viewer.

The selection of the edit control 201 permits the designing user to edit any of the data fields 211 through 215. The preview control 202 allows the designing user to see a preview of how the interactive video would be presented. The “get video” control 203 permits the user to get the interactive video, or at least sufficient data that o m the designing user could generate the interactive video. For instance, the get video control 203 might cause the retrieval of HyperText Markup Language (HTML) or other markup language code. A Web page designer may then insert the HTML code in the appropriate portion of a Web page that corresponds to a frame set aside for video presentation.

The selection of the preview control 202 or the get video control 203 may trigger the uploading of any input video, and the uploading of any of the interactive configuration data entered into the configuration interface. In FIG. 1, the uploading of the video is represented by arrow 141, and the uploading of the interactive configuration data is represented by arrow 142. The arrow 146 represents that the interactive video generation computing system 102 may provide the embedded markup that the designer may insert into a web page. The add screen control 204 allows the user to add a further time-based interactive feature to the interactive video. These various controls will be described in further detail below.

The video identifier field 211 contains an identifier that identifies the video that is to have interactive features added thereto. In essence, the video identifier field 211 identifies the input video to the process. The interactive features will be overlaid over this video or otherwise visually associated with the video. In one embodiment, the configuration interface 200 may provide a list of videos from which the designing user may choose. In that case, the video identifier 211 would identify which video of that list was selected. Alternatively or in addition, the designing user may have created their own video that he or she would like to be made interactive. In that case, the video identifier 211 may include a path name at which the input video as may be found on the designing computing system 101. If the video is not already present at the generation computing system 102, the configuration interface 200 may also upload a copy of the video from the specified location at the designing computing system 101 to the generation computing system 102 as represented by arrow 141 in FIG. 1.

The video dimensions field 212 may include size dimensions of the video (e.g., height and width of the video in pixels) or perhaps even the length (e.g., in seconds) of the video. The Web page designer may have set aside a frame of a certain size for presentation of the interactive video. The designer may thus specify how big the video needs to be to fit that frame.

The “Send to Friend” Uniform Resource Locator (URL) field 213 specifies an address that a link to the video may be sent from if a viewer of the interactive video were to select a “Send to Friend” interactive control within the interactive video. Upon selecting such a link, an e-mail template might open with the body of the e-mail including text that references the URL of the interactive video. The viewing user may then type in the e-mail address of the recipient in the “To” field, and then send the e-mail.

The data integration field 214 specifies integration data for integrating a data input mechanism of the interactive video to an external data input mechanism that resides outside of the interactive video. For instance, the interactive video may include an internal control that permits the user to select one or more products to buy (and specify a number of each to buy) without actually leaving the interactive video player. That data may be provided in the background to an external shopping cart page as the viewer enters that data to the internal shopping cart within the interactive video player. When the viewer navigates to that external shopping cart, the viewer has the convenience of not having to reenter that data into a more complex interface.

The other data field 215 represents that there may be one or more other data fields related to the video that the designing user may enter. For instance, the designed might specify a border color, tint or hue adjustments, or the like.

The add screen control 204 permits the user to add a new screen to the interactive video. This screen may be, for example, a control that is added to the video in conjunction with a screen or other interface that is caused to appear when that control is selected. The control is caused to appear in the video at a specified time within the video. The selection of the control may cause, for example, an HTML page, or another browsable hyperlinked document to appear. In this description and in the claims, a “browsable hyperlinked document” may be any document that includes hyperlinks that, when selected by a user, causes another screen (possible also a browsable hyperlinked document) to appear. The screen may even include another interactive video. Thus, the initial interactive video may be but a root node in a hierarchical tree of nodes in a navigatable tree of interactive videos. Thus, the principles described herein permit a new paradigm in web site navigation, namely, hyperlinked video navigation.

In FIG. 2, the screen data 221 represents example data associated with such a screen. The horizontal ellipses 222 represents that there may be multiple interactive screens associated with the video, although only one instance is detailed in FIG. 2.

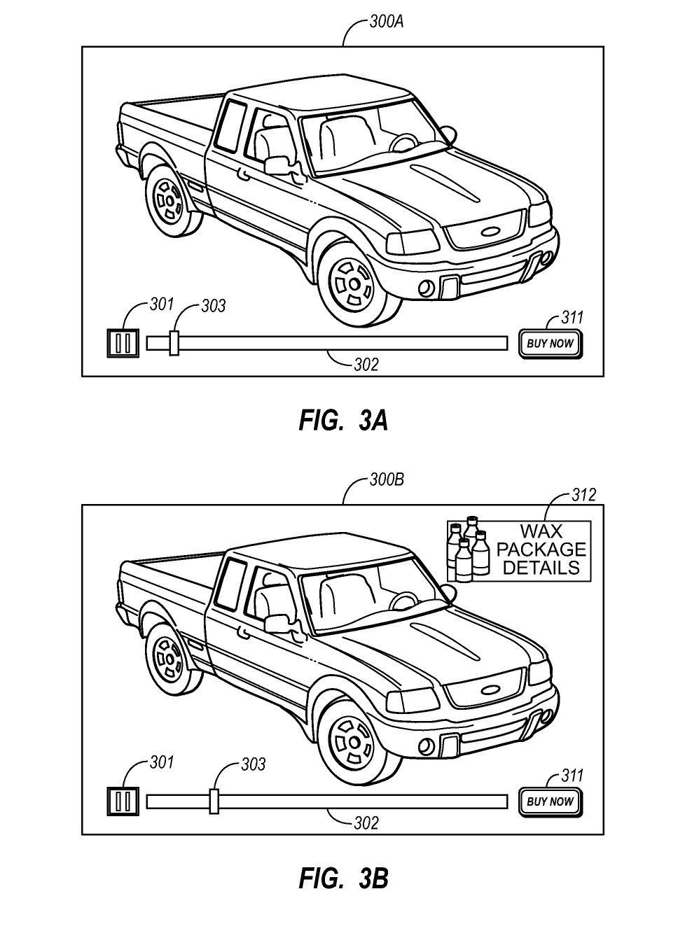

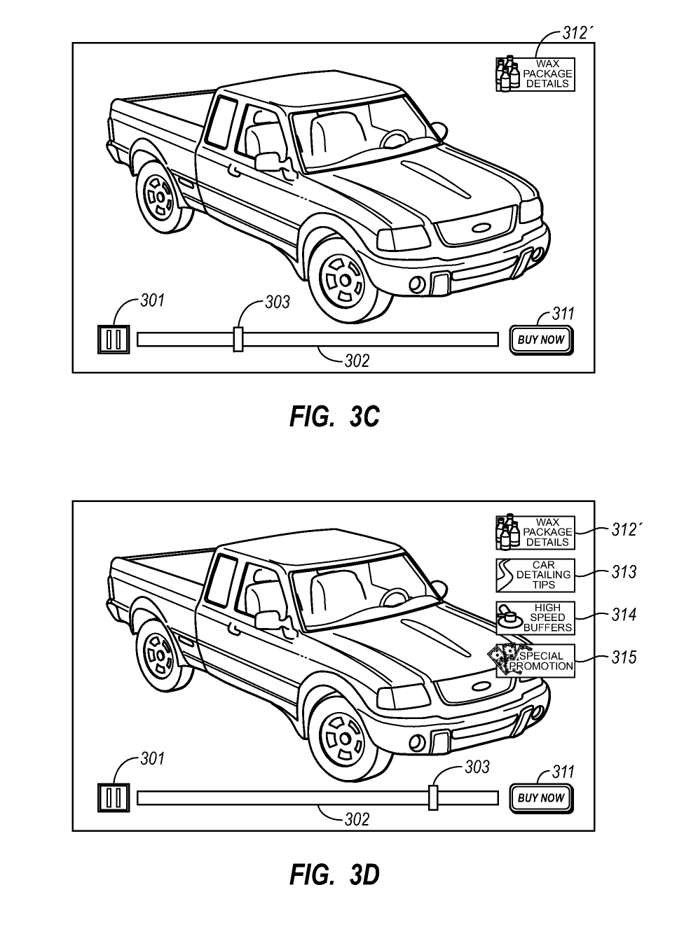

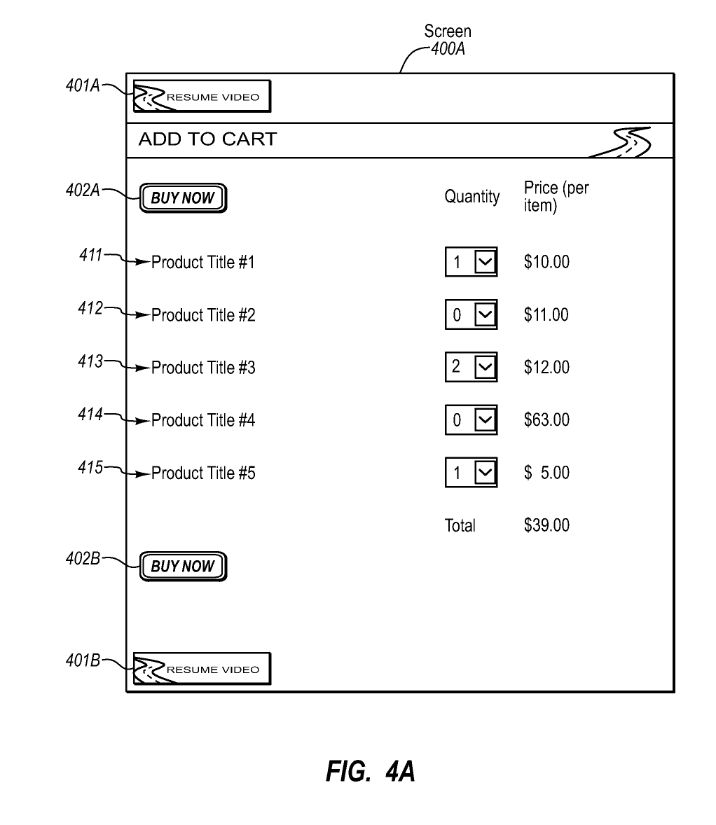

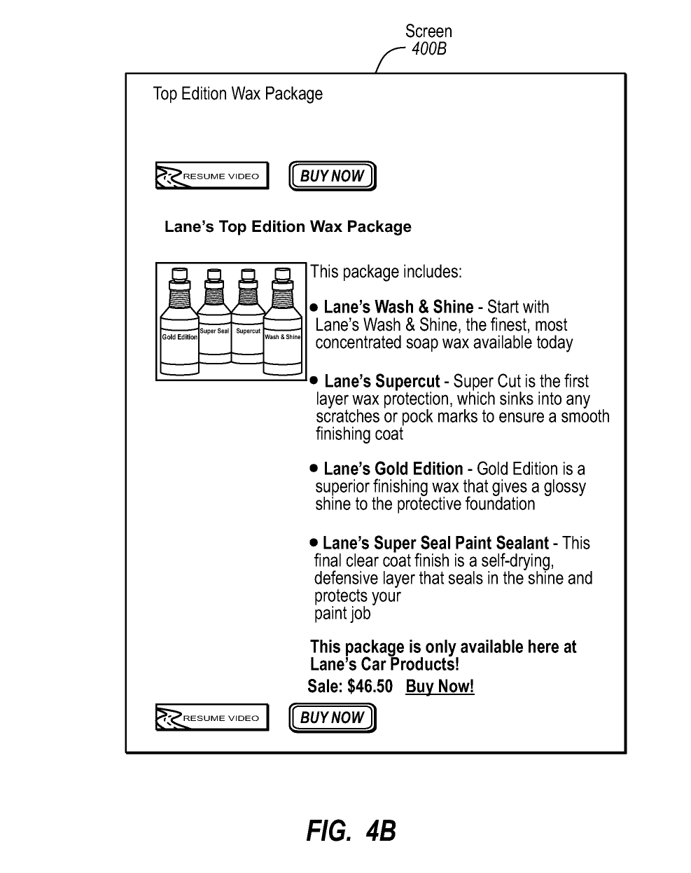

Prior to describing the screen data 221 of FIG. 2, an example interactive video will be described with respect to FIGS. 3A through 3D, and FIG. 4.

FIG. 3A illustrates a user interface 300A as presented by an interactive as video player. The user interface 300A includes a pause and play control 301, a seeker bar 302, and a seeker control 303. Such elements are commonly present in many video players. Nevertheless, these elements will be briefly described. The pause and play control 301 permits the user to pause the video if playing, and play the video if paused. The seeker bar 302 represents the entire duration of the video. The seeker control 303 shows the current position in the video by its relative position within the seeker bar 302. The seeker control 303 begins the video at the left side of the seeker bar 302 and ends the video at the right side of the seeker bar 303. As the video plays, the seeker control 303 moves steadily from left to right. The seeker control 303 may be dragged left to rewind the video to a particular time, or may be dragged right to forward the video to a particular time.

The user interface 300A of FIG. 3A also includes a “Buy Now” control 311. If the viewer selects the “Buy Now” control, the interactive video player may pause the video if playing. Furthermore, the interactive video player may present a simplified shopping cart to the viewer. FIG. 4A illustrates an example of such a simplified shopping cart user interface 400A. The shopping cart includes only 5 product entries 411 through 415, each having an associated product description, quantity selection drop down button, and a price per item. The simplified shopping cart also includes “Resume Video” controls 401A and 401B. Upon selection of the “Resume Video” control, the user interface 300A of FIG. 3A may be returned to, and the video resumes. However, even the decision on whether the video pauses or resumes when an interactive control is selected may be configurable by the designing user. Using the user interface 400, a viewing user may enter purchase data directly from within an interactive video player.

The simplified shopping cart is configurable at the time the designing user as sets up the interactive video. Accordingly, the designing user may select a list of product entries that are best suited for the particular video. For instance, if the designing user sells a wide variety of products, but the video is tailored towards car detailing products, the products within the internal shopping cart might be limited to only car detailing products. This allows the designing user to focus the viewer's purchasing opportunities towards the subject matter that the viewer was mentally concentrating on when viewing the video.

The simplified shopping cart 400A may be integrated with a shopping cart that is external to the interactive video player. For instance, as the viewing user is selecting quantities of particular items for purchase, those changes may be propagated to an external shopping cart. This shopping cart integration may be specified in the data integration field 214 of FIG. 2. For instance, shopping cart 400A may be made to integrate with any on-line vendor shopping cart. When a designer sets up the internal shopping cart, the data integration 214 will include a shopping cart platform identifier (for example, YAHOO®), and a store identifier within that platform. From this information, the interactive video player will be able to identify the associated external shopping cart Web site. The data integration 214 will also include a product identifier for each product to be displayed in the internal shopping cart, as well as a default count that is to be presented when the internal shopping cart is opened.

As an example buying experience, if the viewer were to then select the “Buy Now” controls 402A or 402B in FIG. 4A, the platform and store identifier would be consulted to identify an external shopping cart site. The product identifiers and associated quantities may then be submitted to the external shopping cart so that the external shopping cart may be updated with the data input by the viewer into the internal shopping cart. The user might then be sent to the external shopping cart using as their web browser if the Buy Now controls 402A or 402B were selected. Alternatively, the external shopping cart may be presented also without exiting the interactive video player, as perhaps a window within or associated with the interactive video player. Thus, the viewing user was able to quickly and conveniently purchase items related to a video, without having to research where to go to buy, and without even having to find the products to purchase within the context of a more complex and comprehensive shopping cart.

Referring again to FIG. 3A, the “Buy Now” control 311 might not direct to an internal shopping cart, but to any data input mechanism that is internal to the video player. As another example, suppose the video were a corporate recruiting video, the “Buy Now” button might be replaced with an “Apply Now” button. The viewing user might then be presented with the key data fields that include information related to the application for a job being described in the video. For instance, the viewing user might be prompted to enter his or her name, education, salary expectations, and the like. Upon selecting another “Apply Now” button in the internal Apply Now screen, this information might be integrated with an external corporate recruiting web site, with the appropriate fields already filled in.

Referring back to FIG. 3A, as represented by the leftward position of the seeker control 303, the user interface 300A presents the video in an early stage. As the video progresses, the user interface eventually reaches the state 300B shown in FIG. 3B. Here, an interactive control 312 makes its appearance onto the video. The interactive control 312 may even be made transparent, and may enter the display with a designated animation. For instance, the interactive control may appear, then be made quite large as it appears in FIG. 3B, and then made small again. Perhaps, the words “Click Me” may also be temporarily displayed on the control. Any animation as may be chosen, but an ideal animation might be something that is sufficient to make the viewing user aware that there is a control that may be selected, and the general nature of information that might be expected if the control is selected. For instance, if a control will, upon selection, describe more information regarding a particular product, the control might be made to appear at the time the product is being demonstrated in the video, perhaps close to the time of expected maximum viewer interest in that item. In addition, the control might appear with some smaller descriptive text superimposed on the control. FIG. 4B illustrates a screen 400B that might appear should the interactive control 312′ be selected. This screen might appear within the video player presentation area, in a separate pop-up, or within a new video, as configured in the corresponding screen data.

FIG. 3C shows the user interface 300C in which the control 312′ is shown in a later state after the initial animation is completed. As the video progresses, perhaps other controls may be made to appear on the screen at particular designated times, also optionally with some designated animation. For instance, FIG. 3D illustrates the user interface 300D in a later stage of video presentation (note the seeker control 303 towards the right of the seeker bar 302). This state occurs after the controls 313 through 315 were caused to appear at the appropriate time, and with an appropriately eye-catching animation. The viewing user might then select any of these controls 311, 312′, 313, 314 and 315, to thereby display an appropriate corresponding screen.

If the video is rewound, the controls may be left within the interactive display. For instance, if the video is rewound from the state of FIG. 3D back to the state of FIG. 3A, perhaps the controls 312′, 313, 314 and 315 remain displayed. This might be consistent with a good viewer experience since the viewer has already as been made aware of the controls through the properly timed initial animated appearance of the control that occurred during the initial playing of the video. In that case, perhaps the control is once again animated in some way at the particular designated play times, albeit with perhaps using a less prominent animation.

Returning back to FIG. 2, the various fields and controls of the screen data 221 will now be described. Each piece of screen data might describe a particular control and corresponding screen that is selected when that control is selected. For instance, the screen data 221 of FIG. 2 might correspond to the “Buy Now” control 311 of FIGS. 3A through 3D. Similar data might describe each of the controls 312′, 313, 314 and 315, and the correspondence screens that appear upon selection of the particular control.

The markup identification field 231 identifies the data used to render the screen that will be displayed when the corresponding control is selected. In one embodiment, that data may be formatted as code, although that is not required. The markup identifier may describe a location of the HTML code which may be uploaded to the generation computing system.

The button identification field 232 identifies the graphics of the control that displays over the video. In one embodiment, that data may be, for example, a JPEG file. The graphic may be displayed in opaque form. The graphic may also be displayed in partially transparent form allowing the underlying video to be viewed. The button identifier 232 may describe a location of the graphic that is to be used as the control. In that case, the graphic is uploaded to the generation computing system.

The screen data 221 may also include any text to include on the control. For example, in FIG. 3A, the control 312 is shown with the text “Wax Package Details”. Font size field 233 specifies the font size of that text. Overlay text field 234 represents the position to place the text with respect to the control graphic.

Animation type field 235 specifies the type of animation to be used when the control enters the video. Examples of animation include sliding in from the top, side, or bottom of the video display area.

The opens in field 236 defines where the corresponding screen is opened when the control is selected. For instance, the screen might be displayed in place of the video in the video player itself, within a pop up box, or perhaps even in a new window.

The “Buy Now” field 237 specifies whether or not the control leads to the internal shopping cart.

The ping times field 238 specifies that time that the control is to initially appear, and any subsequent times that the control is to once again undergo animation.

The other field 239 represents that there may be other screen oriented fields or controls within the screen data 221.

The upload new markup control 240 may be used to allow the designing user to again upload new markup for the control to thereby change the screen that is displayed upon selection of that control.

Referring back to FIG. 1, an interactive video generation module 121 at the generation computing system 102 receives the video (as represented by arrow 141) as well as the interaction configuration data (as represented by the arrow 142).

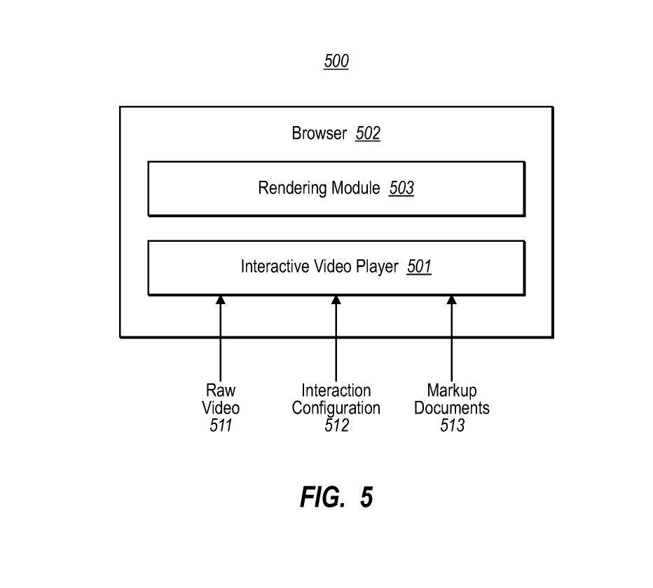

FIG. 5 illustrates an example architecture 500 of an interactive video player 501 in accordance with one embodiment of the invention. In this embodiment, the interactive video player 501 may be incorporated as part of a browser 502 or perhaps may provide pre-rendered data to the browser. The interactive video player 501 receives three items of input including 1) the raw video 511, 2) interaction configuration data 512, and 3) screen markup documents 513.

The raw video 511 may be video as provided by the designing user, perhaps with some resizing to fit the video dimensions specified by the user. The interaction configuration data 512 may be represented by some of the interaction configuration data provided by the designing user through the configuration interface, with perhaps some format conversion. For example, in one embodiment, the interactive video player 501 receives the interaction configuration data 512 as XML data. Examples of the configuration data include the border color, the times that particular controls appear, the associated animation, and so forth. Picture files representing the controls may also be provided within the XML albeit in perhaps binary form. The screen markup document 513 may be, for example, the HTML files represented the screens that should appear when a corresponding control is selected.

Referring back to FIG. 1, the generation computing system 102 may be used for generating interactive video data may be different that the computing system that is used to respond to browser requests for such video.

It is highly likely that the count (e.g., thousands and perhaps millions) of viewers accessing the video will be much greater that the count of times that the interactive video is generated (e.g., once). Accordingly, to facilitate high volume access, the various interactive video data is provided by the generation computing system 102 to an interactive video storage computing system 103. For instance, the raw video is provided as represented by the arrow 143 in FIG. 1, the interaction configuration data is provided as represented by the arrow 144 in FIG. 1, and the markup documents are provided as represented by the arrow 145 in FIG. 1. The data may be provided by providing the data into a synchronized folder that is as periodically (e.g., every 10 minutes or so) propagated into the storage computing system 103. The arrows 143, 144 and 145 are shown bidirectionally to support that the raw video, configuration data, and markup documents might be provided back from the storage computing system 103 to the generation computing system 102 under some circumstances. For example, the designing might later edit the interactive video thereby permitting the designing user to once again interface with the configuration interface 211. In that case, the generation computing system 102 may need the interactive video information to further perform edits or permit the designing user to preview the interactive video.

Thus, the embedded HTML that is received into the designers web page may be reference the storage computing system 103 as the source of the interactive video, rather than the generation computing system 102. The storage computing system 103 may even be a load balanced cloud of servers.

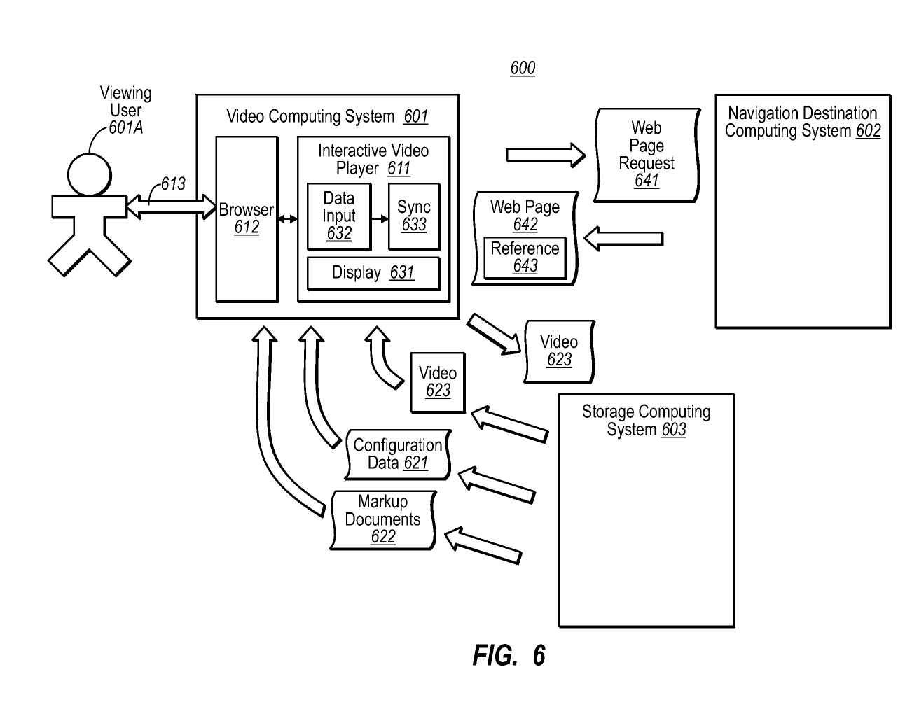

Thus, a designing user may more easily develop an interactive video using a straightforward configuration interface, rather than having to develop custom coding to formulate the interactive video experience. Furthermore, the interactive video experience is rich in that controls may be caused to appear with animation and at high impact times within the video. Those controls, when selected, may provide a continued rich experience as their selection leads to a further opportunity to navigate and find out more information regarding a focused subject. The controls may potentially lead the viewer to a simplified data input mechanism (e.g., a shopping cart) that can be specifically designed by the designer to complement the subject matter of the video. Having described the designing environment, the viewing environment will now be described with respect to FIG. 6.

FIG. 6 illustrates a viewing environment 600 that includes a viewing computing system 601 having a viewing user 601A, a navigation destination computing system 602, and a storage computing system 603. The viewing computing system 601 may be a general purpose computing system and includes a browser 612 that interfaces with a user 601A as represented by bi-directional arrow 613.

The viewing user 601A interfaces with the browser 612 to thereby cause the viewing computing system to issue a network site connection request 641 (e.g., a web page request) to a navigation destination computing system 602. The navigation destination computing system 602 may be, for example, a Web server. For instance, it may be a server affiliated with the designing user 101A of FIG. 1. Recall that in the design process, the designer was provided in one embodiment with embedded markup language that referenced a location at which the interactive video was effective stored. Accordingly, the navigation destination computing system 602 responds to the request with a Web page 642 that includes the embedded markup portion 643 that references the interactive video.

The browser 612 interprets the Web page 642 and renders the Web page so as to viewable by the viewing user. In the process of rendering, however, the browser 612 encounters the embedded markup language 643, and issues a request 644 for the interactive video to the storage computing system 603. The storage computing system 603 of FIG. 6 may be, for example, the same storage computing system 103 as that shown in FIG. 1. Alternatively, the navigation destination computing system 602 may itself host the interactive video. In that case, in FIG. 1, the interactive video generation computing system 102 of FIG. 1, would have provided the interactive video data not to the storage computing system 103, but back to the designing computing system 101.

In response to the request 644, the storage computing system 603 may send the raw video 623 back to the viewing computing system 601. The storage o m computing system 603 may also send the interaction configuration data 621, and the markup documents 622 back to the viewing computing system 601. The interactive video player at the video computing system 601 may then use the raw video 623, the interactive configuration data 621 and the markup documents 622 to present the interactive video. If the interactive video player 611 was not already installed at the viewing computing system 601, the interactive video player 611 may be installed prior to the presentation of the interactive video.

The interactive video player 611 includes a display mechanism 631 for displaying the interactive video. In particular, the interactive video player will display the raw video with the interactive controls designated by the configuration data. If a control is selected, the interactive video player will also cause the corresponding markup document to appear in an appropriate manner. See FIGS. 3A through 3D and 4 for a particular example of a video viewing experience.

The interactive video player also includes a data input mechanism 632 that allows a viewing user to enter data without first exiting the interactive video player. For example, in the example of FIGS. 3A through 3D, if the user were to select the “Buy Now” control, an internal shopping cart of FIG. 4 might appear, allowing the user to select items of interest. The designing user might have even specified default selection items in the internal shopping cart. For instance, when the viewing user selects “Buy Now”, the internal shopping cart might appears with the recommended items already selected with a recommended count. The viewing user may then select those default items and counts, or may edit as appropriate, or may simply return to the video.

The interactive video player also includes a synchronization mechanism 633 that automatically synchronizes at least a portion of the entered data with one or more other network sites. For instance, in the shopping cart example, the items selected may be automatically synchronized with an external vendor shopping cart as previously described. Alternatively, some of the data entered may be synchronized with yet another web site. Consider an example in which the navigation destination computing system 602 is an affiliated Web site for a master vendor. In that case, the navigation destination computing system 602 may cause their vendor identifier to be entered into the data input mechanism 632 of the interactive video player 611. The synchronization mechanism 633 would synchronize the shopping cart data with an external shopping cart site, but would synchronize the vendor identification data with the master vendor site. This would allow the master vendor to monitor the sales activity of their affiliated vendors.

Having described the general embodiments disclosed herein, an example computing system will now be described with respect to the computing system 700 of FIG. 7. The example computing system 700 may be used for any of the designing computing system 101, generation computing system 102, storage computing system 103, viewing computing system 601 and navigation destination computing system 603.

FIG. 7 illustrates a computing system 700, which may implement a message processor in software. Computing systems are now increasingly taking a wide variety of forms. Computing systems may, for example, be handheld devices, appliances, laptop computers, desktop computers, mainframes, distributed computing systems, or even devices that have not conventionally considered a computing system. In this description and in the claims, the term “computing system” is defined broadly as including any device or system (or combination thereof) that includes at least one processor, and a memory capable of having thereon computer-executable instructions that may be executed by the processor. The memory may take any form and may depend on the nature and form of the computing system. A computing system may be distributed over a network environment and may include multiple constituent computing systems.

As illustrated in FIG. 7, in its most basic configuration, a computing system 700 typically includes at least one processing unit 702 and memory 704. The memory 704 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “module” or “component” can refer to software objects or routines that execute on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. An example of such an operation involves the manipulation of data. The computer-executable instructions (and the manipulated data) may be stored in the memory 704 of the computing system 700.

Computing system 700 may also contain communication channels 708 that allow the computing system 700 to communicate with other message processors over, for example, network 710. Communication channels 708 are examples of m communications media. Communications media typically embody computer-readable instructions, data structures, program modules, or other data in a modulated data signal such as a carrier wave or other transport mechanism and include any information-delivery media. By way of example, and not limitation, communications media include wired media, such as wired networks and direct-wired connections, and wireless media such as acoustic, radio, infrared, and other wireless media. The term computer-readable media as used herein includes both storage media and communications media.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product comprising one or more computer-readable media having thereon computer-executable instructions that, when executed by one or more processors of a computing system, cause the computing system to instantiate an interactive video player that comprises the following:
a display mechanism for displaying the interactive video; and
a data input mechanism that allows a viewing user to enter data without first exiting the interactive video player.

2. A computer program product in accordance with claim 1, wherein the interactive video play further comprises:
a synchronizing mechanism that automatically synchronizes at least a portion of the entered data with a network site.

3. A computer program product in accordance with claim 2, wherein the network site is a first network site, the data input mechanism further permits vender identification data to be input, wherein the synchronization mechanism synchronizes the vendor identification data with a second network site that is different than the first network site.

4. A computer program product in accordance with claim 2, wherein the network site is an external network site outside of the interactive video player.

5. A computer program product in accordance with claim 4 wherein the external network site is a separate Web page.

6. A computer program product in accordance with claim 5, wherein the Web page may be viewed within the external video player.

7. A computer program product in accordance with claim 1, wherein the data comprises purchase data, and the external network site includes an external shopping cart.

8. A computer program product in accordance with claim 7, wherein the purchase data is purchase customization data.

9. A computer program product in accordance with claim 7, wherein the purchase data is item selection data.

10. A computer program product in accordance with claim 1, wherein the data comprises employment application data, and the external network site includes an employment application.

11. A computer program product in accordance with claim 1, wherein the data possible to be inputted by the user into the data input mechanism is configured by a video provider.

12. A computer program product in accordance with claim 1, wherein the one or more computer-readable media are physical storage and/or memory media.

13. A computer program product comprising one or more computer-readable media having thereon computer-executable instructions that, when executed by one or more processors of a computing system, cause the computing system to perform a method for allowing a remote user to remotely configure an interactive video experience, the method comprising:
an act of detecting that the remote user desires to create an interactive video;
an act of causing a configuration interface to be presented to the remote user, the remote interface allowing the remote user to select a non-interactive video to convert to an interactive video, and allows the user to specify an interactive aspect to be present in the interactive video; and
an act of automatically generating an interactive video or at last information from which the interactive video may be later constructed based on the non-interactive video selected by the customer through the configuration interface, wherein the interactive video includes one or more interactive aspects including at least the custom interactive aspect specified by the remote user through the configuration interface.

14. The computer program product in accordance with claim 13, wherein the interactive video is in the form of data configured by the remote user that, when interpreted by a video player, causes the video player to generate the interactive video.

15. The computer program product in accordance with claim 13, wherein the interactive aspect may be specified by the user by selecting a predefined offering provided in the configuration interface.

16. The computer program product in accordance with claim 13, wherein the interactive aspect may be defined by the user despite not being expressly offered by the configuration interface.

17. A computer program product in accordance with claim 13, wherein the one or more computer-readable media are physical storage and/or memory media.

18. A computer program product comprising one or more computer-readable media having thereon computer-executable instructions that, when executed by one or more processors of a computing system, cause the computing system to perform a method for causing an interactive video to be presented to a remote user navigating a network, the method comprising:
an act of detecting that the remote user has navigated to a network site that references an interactive video; and
in response to the detection, an act of causing the interactive video to be presented to the remote user, the interactive video including at least one interactive video control that may be selected by the remote user, wherein when the remote user selects the interactive video control, the interactive video causes to be displayed a browsable hyperlinked document that permits further navigation without exiting the network site, and without exiting the interactive video.

19. A computer program product in accordance with claim 18, wherein the one or more computer-readable media are physical storage and/or memory media.
